(19) United States
(12) Patent Application Publication
(10) Pub. No.: US 2026/0096946 A1
(43) Pub. Date: Apr. 9, 2026

(54) PENILE TREATMENT DEVICES AND METHODS

(71) Applicant: CurvX Medical LLC, Orange, CA (US)

(72) Inventor: Michael E. Williams, Orange, CA (US)

(21) Appl. No.: 19/349,832

(22) Filed: Oct. 3, 2025

Related U.S. Application Data
(60) Provisional application No. 63/703,850, filed on Oct. 4, 2024.

(51) Int. Cl. A61H 19/00; A61H 7/00

(52) U.S. Cl. CPC A61H 19/32; A61H 7/001; A61H 2201/1676

(57) ABSTRACT

Devices and methods for treating penile conditions are disclosed. A penile treatment device can include a sleeve and a frame. The sleeve can be configured to receive a penis of the human body. The sleeve can be configured to radially contract around and grip the penis in response to axial tension. The frame can be configured to be disposed at least partly around the sleeve and extend along at least a portion of a length of the penis. The frame can include a first support, a second support, and an end cap. The second support can be pivotable relative to the first support to apply a transverse bending force to the penis. The end cap can be coupled to the second support and can be configured to secure the sleeve to the frame. The frame can be lengthened to axially tension the penis.

### CROSS REFERENCE

All applications for which a foreign or domestic priority claim is identified in the Application Data Sheet as filed with the present application are hereby incorporated by reference under 37 CFR 1.57. This application claims the priority benefit of U.S. Provisional Patent Application No. 63/703,850, filed Oct. 4, 2024, the entirety of which is incorporated by reference herein. Any differences between the priority document(s) and the present document shall not be construed as a disclaimer or disavowal.

### BACKGROUND

### Field

The present disclosure relates to medical devices and methods for treating penile diseases. More specifically, the present disclosure describes non-surgical devices and methods for applying therapeutic penile bending and stretching.

### Description of Certain Related Art

Peyronie's disease is a condition in which scar tissue, called plaque, builds-up under the skin of the penis. The plaque pulls on and/or decreases the flexibility of surrounding tissue, causing the penis to bend, curve, lose length, or lose girth. Such penile aberrations can result in painful erections, making sexual intercourse painful, difficult, or impossible. It is estimated that between 1-10% of men suffer from Peyronie's disease worldwide.

### BRIEF DESCRIPTION OF THE DRAWINGS

FIG. 1 depicts a longitudinal cross-sectional view of a penile treatment device according to a first embodiment.

FIG. 2 depicts an exploded view of the penile treatment device of FIG. 1.

FIG. 3A depicts a sleeve of the penile treatment device of FIG. 1 in a relaxed configuration.

FIG. 3B depicts the sleeve of FIG. 3B in a tensioned configuration.

FIG. 4A depicts a longitudinal cross-sectional view of a body stop of the penile treatment device of FIG. 1.

FIG. 4B depicts a transverse cross-sectional view of the body stop of FIG. 4A.

FIG. 5A depicts a longitudinal cross-sectional view of a pivoting portion of the penile treatment device of FIG. 1.

FIG. 5B depicts a transverse cross-sectional view of the pivoting portion of FIG. 4A.

FIG. 6 depicts an exploded view of a hinge of the pivoting portion of FIG. 4A.

FIG. 7A depicts an end cap of the penile treatment device of FIG. 1 with a locking mechanism in an unlocked configuration.

FIG. 7B depicts the end cap of FIG. 7A with the locking mechanism in a locked configuration.

FIG. 8A depicts a longitudinal cross-sectional view of a proximal extension segment of the penile treatment device of FIG. 1.

FIG. 8B depicts a transverse cross-sectional view of the proximal extension segment of FIG. 8A.

FIG. 8C depicts a longitudinal cross-sectional view of a distal extension segment of the penile treatment device of FIG. 1.

FIG. 9A depicts a longitudinal cross-sectional view of a penile treatment device without extension segments installed.

FIG. 9B depicts a longitudinal cross-sectional view of a penile treatment device with one extension segment installed.

FIG. 9C depicts a longitudinal cross-sectional view of a penile treatment device with two extension segments installed.

FIG. 10 depicts step grooving of an interior wall of a frame of the penile treatment device of FIG. 1.

FIGS. 11A-11E depict steps in the operation of the penile treatment device during treatment of a penis.

FIG. 12A depicts a transverse cross-sectional view of a frame according to a second embodiment of the penile treatment device.

FIG. 12B depicts a transverse cross-sectional view of an end cap corresponding to the second embodiment of the penile treatment device.

FIG. 12C depicts a longitudinal cross-sectional view of the end cap of FIG. 12B.

FIG. 13A depicts a sleeve according to a third embodiment of the penile treatment device.

FIG. 13B depicts a transverse cross-sectional view of a frame according to the third embodiment of the penile treatment device.

FIG. 13C depicts a transverse cross-sectional view of an end cap corresponding to the third embodiment of the penile treatment device.

FIG. 13D depicts a longitudinal cross-sectional view of the end cap of FIG. 13C.

FIG. 13E depicts a front perspective view of the frame according to the third embodiment of the penile treatment device.

FIG. 13F depicts a rear perspective of the frame according to the third embodiment of the penile treatment device.

FIG. 13G depicts a top perspective view of the frame in a non-extended configuration according to the third embodiment of the penile treatment device.

FIG. 13H depicts a top perspective view of the frame in an extended configuration according to the third embodiment of the penile treatment device.

FIG. 14A depicts a transverse cross-sectional view of a fourth embodiment of the penile treatment device.

FIG. 14B depicts an exploded view of the penile treatment device of FIG. 14A.

FIG. 14C depicts a side view of an end cap corresponding to the fourth embodiment of the penile treatment device of FIG. 14A.

FIG. 14D depicts a bottom view of the end cap of FIG. 14C.

### DETAILED DESCRIPTION OF CERTAIN EMBODIMENTS

The present disclosure describes various devices and methods for treating penile diseases, or for other uses. For example, the devices and methods disclosed herein can be used to treat Peyronie's disease or other penile conditions. The devices and methods disclosed herein can be used to apply therapeutic bending, traction, and/or tension to a penis to remedy aberrations, scarring, and/or other maladies. The devices and methods disclosed herein can be used to correct aberrant penile curvature and restore or improve penile length and/or girth. The devices and methods disclosed herein can be used as part of a penile treatment regimen overseen by a medical professional. The devices and methods disclosed herein can offer a comfortable, effective, and affordable solution for men suffering from Peyronie's disease. The devices and methods have the potential to significantly improve the quality of life for those affected by this condition. In various embodiments, a user can easily adjust the length of the device or the placement of a correcting structure (e.g., hinge) in relation to a portion of the user's anatomy (e.g., a curve in the penis) by adding or removing segments of the device. Pain tolerance is in full control of the user, as they can expand the device slowly, causing tension on the penis shaft to a pain level they can tolerate, and then progressively extend it as tolerated. Because certain embodiments have no direct compression on the penis, and/or the force of the traction is distributed generally evenly across the head of the penis, there is significantly less discomfort, greater stability, and/or less slippage.

### 1. Overview

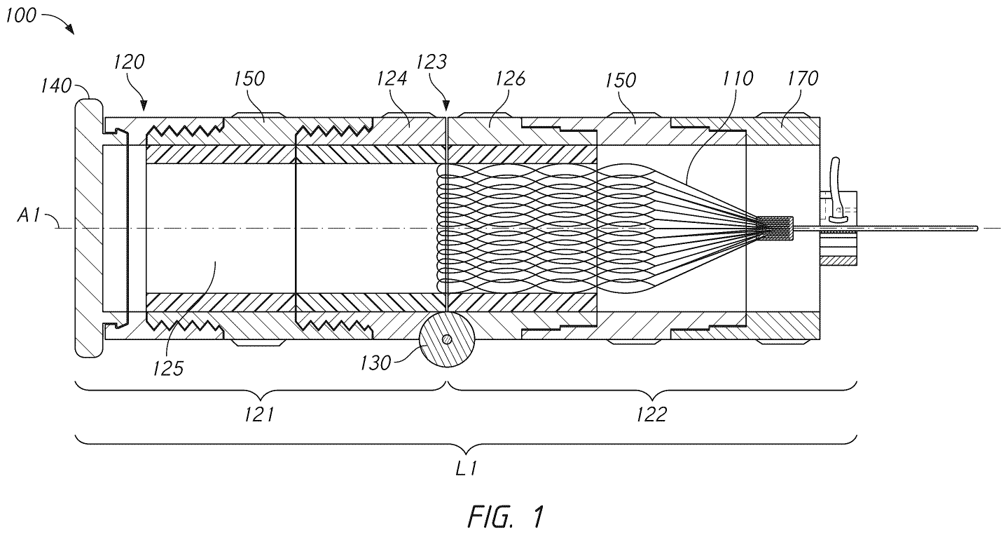

FIGS. 1-14D depict various aspects, configurations, and embodiments of a penile treatment device 100, 200, 300, 400. The penile treatment device 100, 200, 300, 400 can be used to apply therapeutic bending and/or stretching to a penis 10 of a human body. Any feature, structure, or element of any embodiment can be incorporated into any other embodiment. An overview of certain aspects of these embodiments is presented below, with additional detail further below.

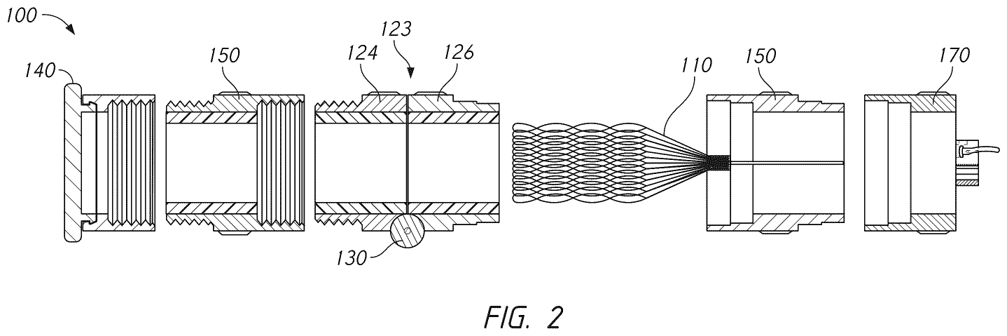

FIGS. 1-11E depict a first embodiment of a penile treatment device 100. FIG. 1 depicts a longitudinal cross-sectional view of the penile treatment device 100 in an assembled state. FIG. 2 depicts an exploded view of the penile treatment device 100 of FIG. 1. As shown in FIGS. 1-2, the penile treatment device 100 can include a sleeve 110 and a frame 120.

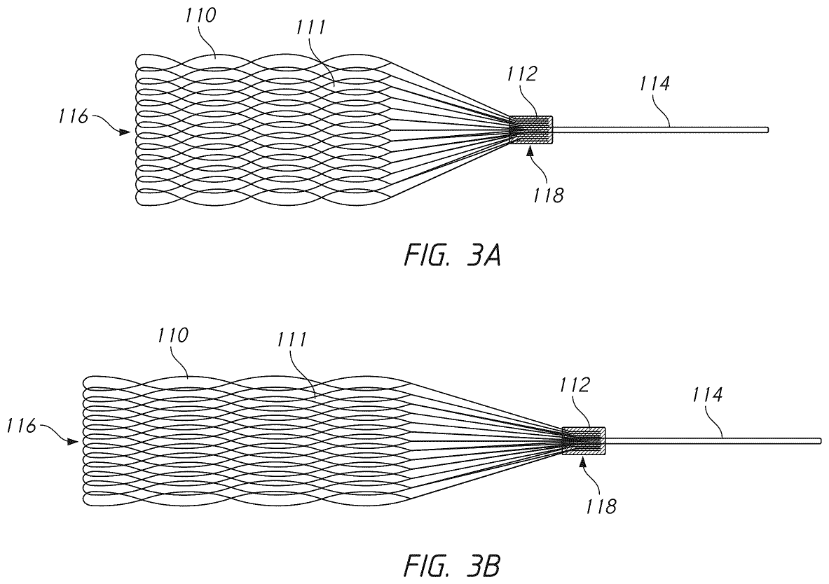

As illustrated in FIGS. 3A-3B, the sleeve 110 can include a grasping portion 111 and a securing element 112. In some embodiments, the grasping portion has an elongate element 114. The sleeve 110 can be dimensioned to receive at least a portion of a user's penis 10. For example, the grasping portion 111 can be fitted over and/or around a portion of the penis and then secured to the frame 120 with the securing element 112 and/or elongate element 114. In certain implementations, the grasping portion 111 comprises a mesh, net, matrix, fiber network, sock, or otherwise.

The frame 120 can include a proximal portion 121, a distal portion 122, and a bending member, such as a hinge 130. The frame 120 can include an interior channel 125 for receiving the sleeve 110 and a user's penis 10. The frame 120 can include one or more extension segments 150. The proximal portion 121 can include a body stop 140 and a first support 124. In certain implementations, the proximal portion 121 includes one or more proximal extension segments 152. The distal portion 122 can include a second support 126 and an end member, such as an end cap 170. In certain implementations, the proximal portion 121 includes one or more distal extension segments 154. The proximal portion 121 can be coupled to the distal portion 122 by the bending member (e.g., hinge 130). The end cap 170 can include a locking mechanism 172 for securing the sleeve 110 to the frame 120. The locking mechanism 172 can be a lock. In use, a plurality of (e.g., two or more) segments of the proximal portion 121 can be axially translated away from each other to extend a length L1 of the frame 120 and apply axial tension to the user's penis 10. The first support 124, the second support 126, and the hinge 130 can form a pivoting portion 123. The distal portion 122 can be pivoted relative to the proximal portion 121 at the hinge 130 to apply therapeutic bending to the user's penis 10.

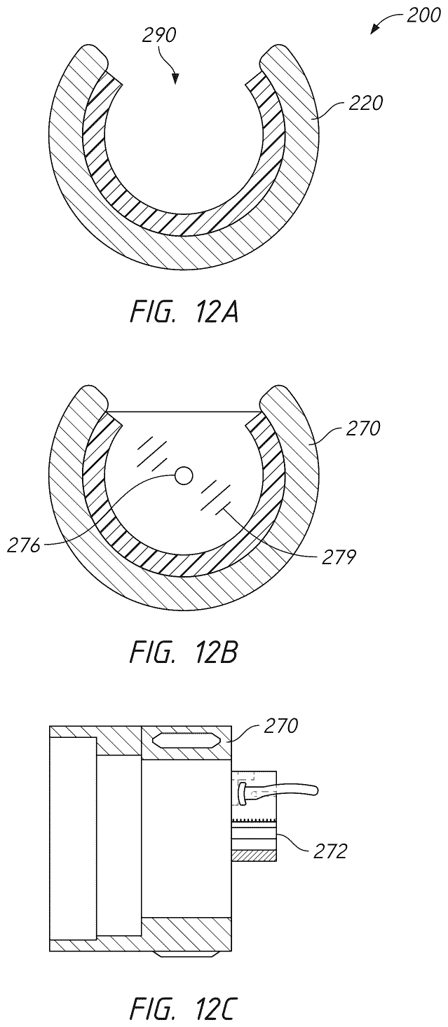

FIGS. 12A-14D illustrate additional embodiments of a penile treatment device 200, 300, 400, which can include any combination of the features of the penile treatment device 100 of FIGS. 1-11D. Many of the features of the penile treatment devices 200, 300, 400 are the same as, or similar to, the features described above in connection with the penile treatment device 100 of FIGS. 1-11E and can be used interchangeably. To illustrate such correspondence, many of the numerals used to identify features of the penile treatment devices 200, 300, 400 are incremented by a factor of one hundred relative to the numerals used in connection with the penile treatment device 100 of FIGS. 1-11E. For example, the frame 120 can be replaced with the frame 220 in the device 100 and/or the frame 220 can be replaced with the frame 120 in the device 200. This numbering system is used throughout this specification. Any component or step disclosed in any embodiment in this specification can be used in any other embodiment. These and other features are described in more detail below.

### 2. Sleeve

As shown in FIGS. 1-2, the penile treatment device 100 can include a sleeve 110. The sleeve 110 can function to grip the penis 10 to facilitate axial tensioning (e.g., longitudinal stretching) and/or lateral tensioning (e.g., bending or sideway stretching) of the penis 10. The sleeve 110 can, in various implementations, provide a barrier between the user's penis 10 and the frame 120 such that the frame 120 does not directly contact at least a portion the user's penis 10 that is inserted into the sleeve 110. The sleeve 110 can provide cushioning for the user's penis 10.

With reference to FIGS. 3A-3B, the illustrated sleeve 110 includes a grasping portion 111, a securing element 112, and an elongate element 114. Some embodiments do not include a securing element 112 and/or an elongate element 114. The grasping portion 111 can be dimensioned to receive a user's penis 10. The grasping portion 111 can be pulled over a user's penis 10 to circumferentially cover some or all of the user's penis 10. In some variants, the sleeve 110 can receive and cover at least the head (e.g., glans) of the user's penis 10. In some embodiments, the sleeve 110 can be dimensioned to cover at least a majority of the longitudinal length of the user's penis 10. In certain embodiments, the sleeve 110 can be dimensioned to cover only the head (e.g., glans) of the user's penis 10. In certain embodiments, the sleeve 110 is configured to not grasp any skin not on the head and/or uncircumcised skin. The grasping portion 111 can include an open end 116 for inserting the penis 10 into the grasping portion 111.

The grasping portion 111 can comprise a flexible, cloth-like material. The grasping portion 111 can be a generally tubular structure. As shown in FIGS. 1-3B, the grasping portion 111 can be formed as a cylindrical woven mesh. For example, the grasping portion 111 can include a woven structure similar to a Chinese finger trap toy, a towing sock, or a strain relief grip. The sleeve 110 can be made from any suitable material, including but not limited to, cloth, Kevlar, fibers, plastics, or the like.

With reference to FIGS. 3A-3B, the sleeve 110 can be configured to expand and contract. For example, the woven and/or mesh structure of the grasping portion 111 can enable the sleeve 110 to radially contract (e.g., toward a radial center) in response to being axially tensioned along a longitudinal axis of the sleeve 110. Accordingly, the sleeve 110 can be transitioned from a relaxed configuration to a tensioned configuration by applying axial tension to the sleeve 110. In some embodiments, when the sleeve 110 is in the axially tensioned state, the longitudinal length of the sleeve 110 can be least about 50%, or at least about 75% of the longitudinal length L1 of the frame 120. In some embodiments, when the sleeve 110 is in the axially tensioned state, the longitudinal length L1 of the sleeve 110 can be less than about 50%, or less than about 75% of the longitudinal length L1 of the frame 120.

FIG. 3A depicts the sleeve 110 of the penile treatment device 100 of FIG. 1 in a relaxed configuration. In the relaxed configuration (e.g., when the sleeve 110 is not axially tensioned), the grasping portion 111 can have a larger diameter and a shorter length. When the sleeve 110 is in the relaxed configuration, the larger diameter of the grasping portion 111 can enable a user's penis 10 to be more easily inserted into the open end 116 of the sleeve 110.

FIG. 3B depicts the sleeve 110 of FIG. 3A in an axially tensioned configuration. As shown in FIG. 3B, axial tensioning of the sleeve 110 can cause the grasping portion 111 to lengthen and radially contract to a smaller diameter. When the sleeve 110 is axially tensioned while covering a penis 10, the grasping portion 111 can radially contract around and grip the penis 10.

Compared to other gripping devices (e.g., a clamp), the sleeve 110 can advantageously reduce the chance of slippage of the user's penis 10 out of the penile treatment device 100 during axial tensioning, can reduce pain and discomfort, and/or provide other benefits. In some embodiments, a longer sleeve 110 can be beneficial, for example because it distributes the gripping force over a greater area and/or reduces the chance of slipping. In some embodiments, a shorter sleeve 110 (e.g., a sleeve 110 that is sized to only cover the glans of the penis 10) can be beneficial, for example because it can grip a smaller portion of the user's penis 10.

As shown in FIGS. 1-3B, in some embodiments, the sleeve 110 (e.g., the grasping portion 111 of the sleeve 110) can include an open end 116 and an opposing closed end 118. The securing element 112 can secure one end of the grasping portion 111 together to form the closed end 118. The securing element 112 can couple the elongate element 114 to the grasping portion 111. The securing element 112 can be any structure for securing an end of the grasping portion 111 together. For example, the securing element 112 can be a crimp, a heat swedge, a hose clamp, a string, an elastic band, a mechanical fastener, or any other circumferential constricting device. In some embodiments, the securing element 112 can be formed by heat bonding ends of the grasping portion 111 together.

As shown in FIGS. 1-3B, the elongate element 114 can extend from the grasping portion 111 along the central longitudinal axis A1 of the sleeve 110. The elongate element 114 can function to couple the sleeve 110 to the frame 120. The elongate element 114 can be used to apply axial tension to the sleeve 110. In some embodiments, when the grasping portion 111 is installed on a penis 10, the elongate element 114 can be pulled in a distal direction to axially tension the grasping portion 111.

As shown in FIG. 1, when the penile treatment device 100 is assembled, the elongate element 114 can extend through the end cap 170. The elongate element 114 can be secured to the end cap 170 by the locking mechanism 172. The elongate element 114 can be extended a specific distance through the end cap 170 to increase or decrease the amount of axial tension applied to the grasping portion 111. The elongate element 114 can be secured to the grasping portion 111 by the securing element 112.

In some embodiments, the elongate element 114 can include an elongate body and one or more locking features. The locking features can be disposed along the elongate body at discrete locations. The locking features can interface with the locking mechanism 172 of the end cap 170 to secure the elongate element 114 to the end cap 170 at one of the discrete locations. The elongate body can be a flexible, semi-flexible, or rigid structure. The elongate element 114 can be formed as any of a multitude of different structures capable of being used to apply tension to the sleeve 110. In some embodiments, the elongate body can be any of a string, a rod, a pin, a cord, a cable, a filament, or the like. In some embodiments, the locking features can be formed as protrusions, recesses, teeth, knots, beads, or the like. For example, the elongate element 114 can include a structure similar to a toothed portion of a zip tie. In some embodiments, the elongate element 114 may not include locking features. In some embodiments, the elongate element 114 can be formed integrally with the grasping portion 111 (e.g., a unitary piece). In some embodiments, the elongate element 114 can be a separate structure that is permanently or detachably coupled to the grasping portion 111. The elongate element 114 can be made from any suitable material, including but not limited to, Kevlar, cloth, nylon, metal, plastic, or the like.

### 3. Frame

As shown in FIGS. 1-2, the penile treatment device 100 can include a frame 120. The frame 120 can be formed as a substantially rigid tubular structure. The frame 120 can include an interior channel 125 dimensioned to receive the user's penis 10 and the sleeve 110. The frame 120 can be disposed at least partly around the sleeve 110. The frame 120 can extend along at least a portion of a length of the user's penis 10. In some embodiments, the frame 120 can extend along substantially an entire length of the user's penis 10. When the user's penis 10 is inserted into the frame 120, the frame 120 can provide lateral support to and constrain the position of the user's penis 10. The frame 120 can be manipulated to apply a bending force and/or axial tension to the user's penis 10.

The frame 120 can include a proximal portion 121, a distal portion 122, and a hinge 130. The proximal portion 121 can include a body stop 140, a first support 124, and one or more proximal extension segments 152. The distal portion 122 can include a second support 126, an end cap 170, and one or more distal extension segments 154. The proximal portion 121 can be coupled to the distal portion 122 by the hinge 130. The first support 124, the second support 126, and the hinge 130 can form a pivoting portion 123. The distal portion 122 can be pivoted relative to the proximal portion 121 at the hinge 130 to apply therapeutic bending to the user's penis 10. Two or more of the body stop 140, the first support 124, and the proximal extension segment 152 can be axially translated away from each other to extend a length L1 of the frame 120 and apply axial tension to the user's penis 10.

As shown in FIGS. 1-2, one or more of the frame segments (e.g., the body stop 140, the first support 124, the second support 126, the end cap 170, and/or the extension segments 150) can be detachably coupled to each other. In some embodiments, one or more of the frame segments can be integrally formed (e.g., as a unitary piece) or fixedly coupled together.

### 3.1. Body Stop

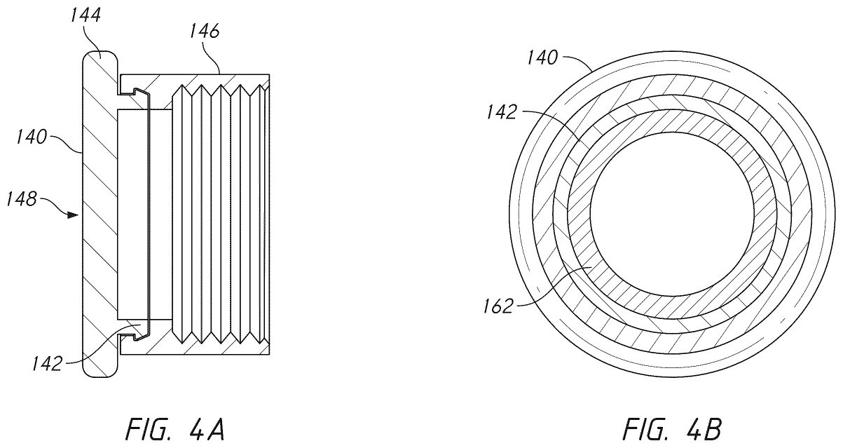

FIG. 4A depicts a longitudinal cross-sectional view of a body stop 140 of the penile treatment device 100 of FIG. 1. FIG. 4B depicts a transverse cross-sectional view of the body stop 140 of FIG. 4A. As shown in FIGS. 4A-4B, the body stop 140 can include a first portion 144 and a second portion 146. The first portion 144 can be formed as a substantially annular structure. The first portion 144 can an include an abutment surface 148 extending substantially perpendicular to a central longitudinal axis A1 of the frame 120. When the penile treatment device 100 is in use, the abutment surface 148 can abut a pubic region 14 of the user (e.g., a region of the user's body surrounding the base of the user's penis 10). The diameter of the frame 120 can increase at the abutment surface 148 to provide the abutment surface 148 with a greater surface area. Axial loads generated by the penile treatment device 100 can be translated into the user's pubic region 14 by the abutment surface 148. The abutment surface 148 can have a larger surface area to distribute axial loads over a larger area to reduce pressure on the user's pubic region 14 and improve comfort.

The second portion 146 can extend from the first portion 144. The second portion 146 can have a tubular structure. In some embodiments, the second portion 146 can be rotatably coupled to the first portion 144, such that the second portion 146 is rotatable relative to the first portion 144 about a central longitudinal axis A1 of the frame 120.

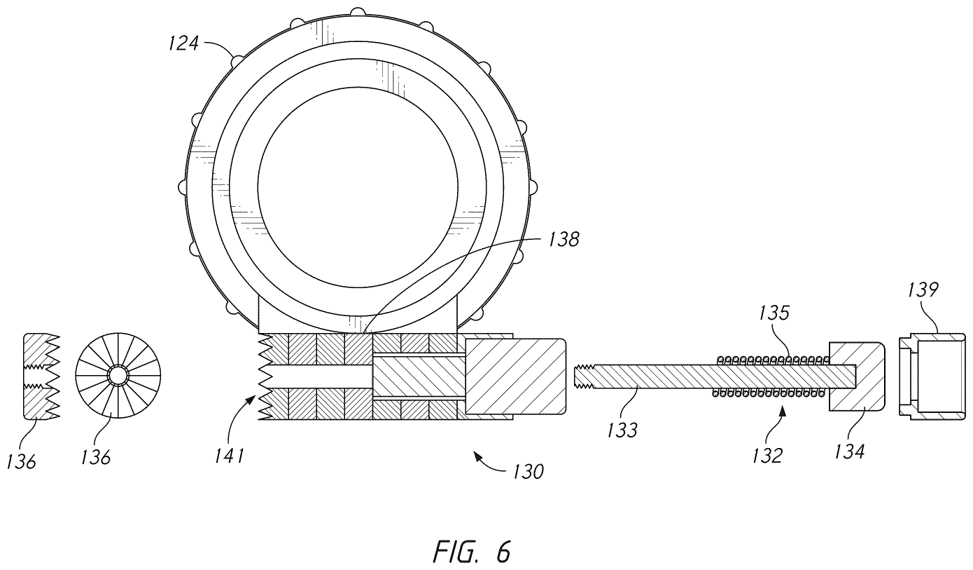

As illustrated, in certain embodiments, the body stop 140 can include a spinning mechanism 142. The first portion 144 can be rotatably coupled to the second portion 146 by the spinning mechanism 142. As shown in FIG. 6, the spinning mechanism 142 can include interlocking features of the first portion 144 and the second portion 146. The interlocking features can be separated by a gap (e.g., micro-gap). The gap can permit the interlocking features to glide and rotate relative to each other. In some embodiments, the spinning mechanism 142 can include any structure for enabling rotation (e.g., ball bearings, sleeve 110 bearing, circumferential track, etc.) In some embodiments, the body stop 140 may not include a spinning mechanism 142. In some implementations, the first portion 144 and the second portion 146 can be formed as a single unitary piece.

As shown in FIG. 4A, the second portion 146 of the body stop 140 can include threading (e.g., step grooving 164) along an inner surface. As will be discussed in more detail below, the threading can enable the body stop 140 to be axially translated away from an adjacent frame segment to increase a length L1 of the frame 120 and apply tension to a user's penis 10.

### 3.2. Pivoting Portion

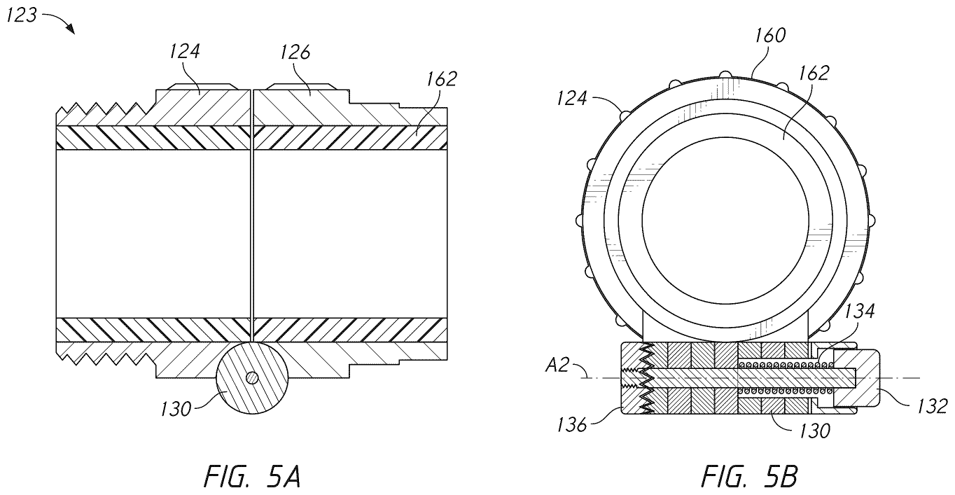

FIG. 5A depicts a longitudinal cross-sectional view of a pivoting portion 123 of the penile treatment device 100 of FIG. 1. FIG. 5B depicts a transverse cross-sectional view of the pivoting portion 123 of FIG. 5A. The pivoting portion 123 can include the first support 124, the second support 126, and the hinge 130. The pivoting portion 123 can enable the proximal portion 121 of the frame 120 to pivot relative to the distal portion 122 of the frame 120. In some embodiments, the first support 124 can be pivotably coupled to the second support 126 by the hinge 130. The hinge 130 can be oriented between the first support 124 and the second support 126 such that the second support 126 is pivotable relative to the first support 124 about a pivot axis A2 that is substantially perpendicular to the central longitudinal axis A1 of the frame 120. Pivoting the second support 126 relative to the first support 124 can apply a transverse bending force to the user's penis 10.

As shown in FIGS. 5A-5B, each of the first support 124 and the second support 126 can be formed as substantially tubular structures. The first support 124 can be directly coupled (e.g., detachably coupled) to the body stop 140, or alternatively to an extension segment 150 (if at least one is installed). The second support 126 can be directly coupled (e.g., detachably coupled) to the end cap 170, or alternatively to an extension segment 150 (if at least one is installed). The first support 124 and the second support 126 can provide lateral support to a user's penis 10. When the second support 126 is pivoted relative to the first support 124, the first support 124 and/or the second support 126 can apply a transverse bending force to the penis 10 to cause the penis 10 to bend.

With reference to FIG. 5B, one or more grips 160 can be disposed on outer surfaces of the first support 124 and/or second support 126. The one or more grips 160 can provide gripping surfaces for a hand of a user. The grips 160 can improve a user's grip on the device to enable the user to more easily operate the penile treatment device 100.

The first support 124 and/or the second support 126 can include padding 162. As shown in FIGS. 5A-5B, the padding 162 can be disposed along an inner surface of the first support 124 and/or the second support 126. The padding 162 can provide cushioning for the user's penis 10 to improve comfort of the user. The user's penis 10 can be depressed into the padding 162 as pressure is applied to the user's penis 10 by the penile treatment device 100. Padding 162 can be made from any suitable material, including but not limited to, foam, cloth, rubber, or the like.

FIG. 6 depicts an exploded view of the hinge 130 shown in FIGS. 5A-5B. The hinge 130 can provide pivoting functionality to the penile treatment device 100. As shown in FIG. 6, the hinge 130 can include a body portion 138, an actuator 132, a biasing member such as a spring 135, and an adjustment member such as an adjustment gear 136.

The body portion 138 can house some or all of the other components of the hinge 130. The body portion 138 can include a channel for receiving the actuator 132. One side of the body portion 138 can include a locking feature 141 for interfacing with the adjustment gear 136.

The locking feature 141 can include a plurality of radially-spaced teeth. The adjustment gear 136 can include a corresponding plurality of radially spaced-teeth shaped to interlock with the plurality of radially-spaced teeth of the locking feature 141 on the body portion 138.

The actuator 132 can be seated within the channel of the body portion 138. The actuator 132 can include a rod portion 133 and a button portion 134. The rod portion 133 can extend through the channel of the body portion 138. One end of the rod portion 133 can be coupled to the adjustment gear 136. An opposing end of the rod portion 133 can be coupled to the button portion 134. The spring 135 can be disposed over the rod portion 133 and disposed between the body portion 138 and the button portion 134. The spring 135 can provide a resistive force to bias the adjustment gear 136 against the locking feature 141.

The hinge 130 can include a button seat 139. The button seat 139 can be disposed in the channel of the body portion 138. The button seat 139 can support the button portion 134 of the actuator 132.

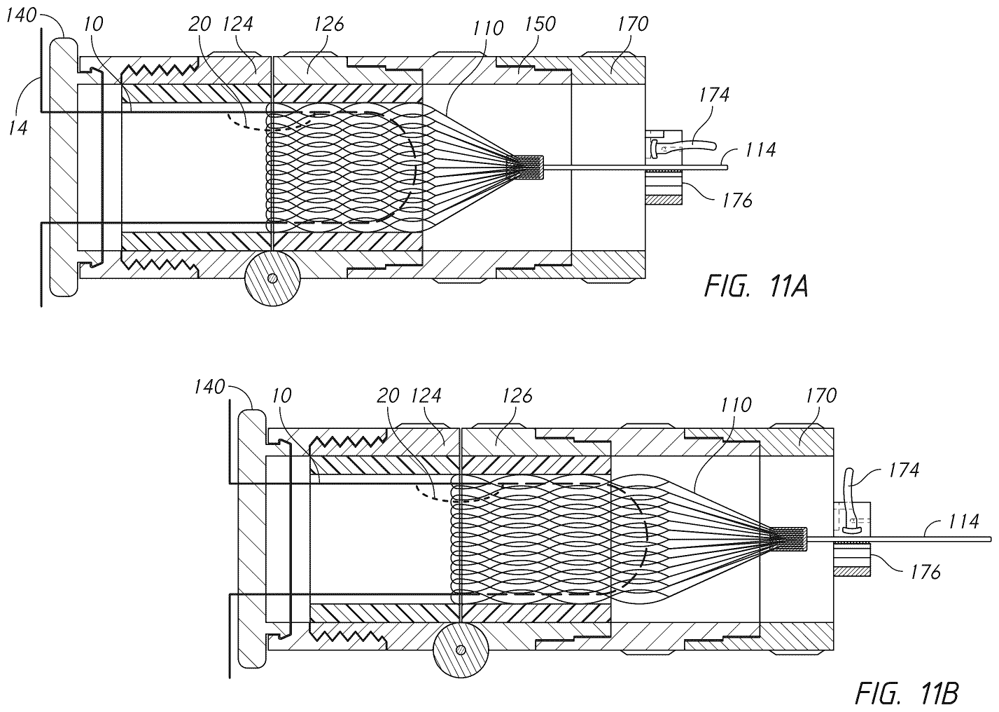

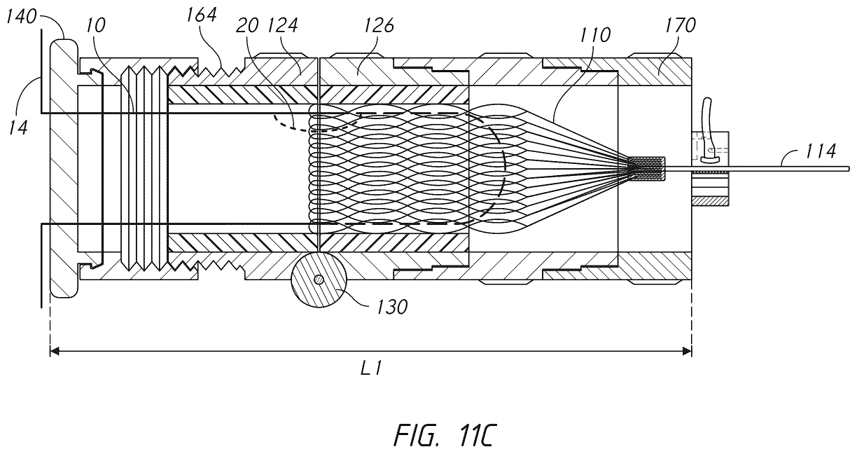

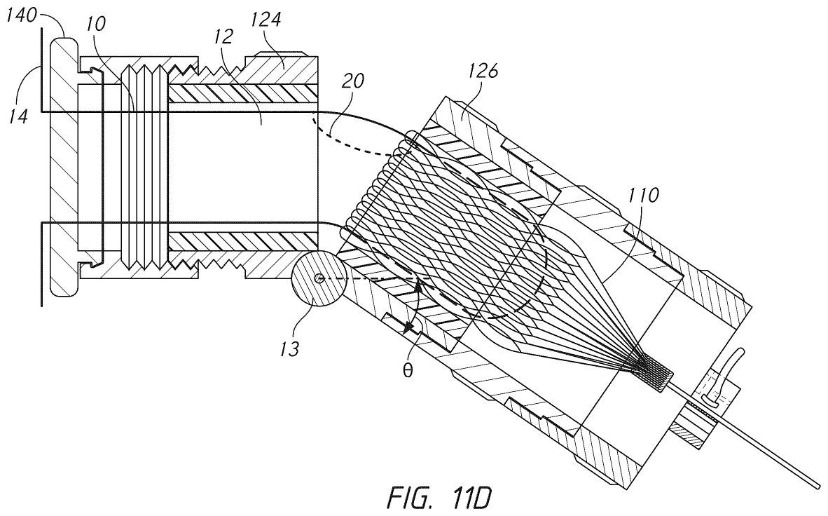

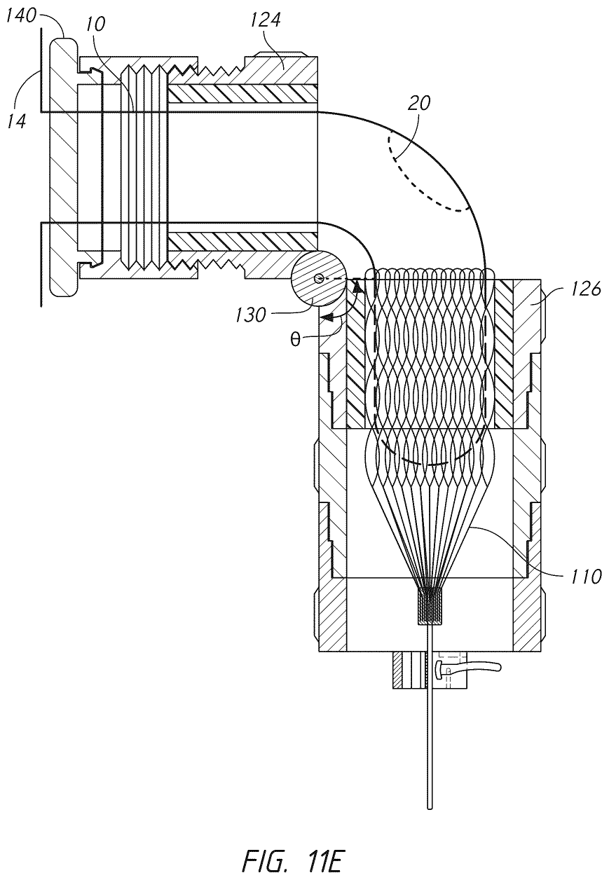

As shown in FIG. 5B, when the adjustment gear 136 is mechanically interlocked with the locking feature 141, the hinge 130 is inhibited or prevented from pivoting. The frame 120 can be transitioned between a first configuration and a second configuration by moving the actuator 132. In the first configuration the second support 126 is freely pivotable relative to the first support 124. In the second configuration the second support 126 is locked at a bend angle θ (see FIG. 11D) relative to the first support 124.

In operation, the actuator 132 can be actuated, such as by being depressed into the body portion 138 by applying a depressive force on the button portion 134. A sufficient force must be applied to overcome the resistive force of the spring 135. Depressing the actuator 132 causes the rod portion 133 to axially translate into the channel of the body portion 138, which in turn advances the adjustment gear 136 away from the locking feature 141, thereby causing the adjustment gear 136 to disengage from the locking feature 141. When the adjustment gear 136 is disengaged from the locking feature 141, the frame 120 is in the first configuration and the hinge 130 can freely pivot within a permitted range of motion. The second support 126 can be pivoted to a specific bend angle. While at that specific bend angle, the adjustment gear 136 can be re-engaged with the locking feature 141 by releasing pressure on the button portion 134 of the actuator 132. Once the depressive force is released, the resistive force of the spring 135 can cause the actuator 132 to translate away from the body portion 138, thereby bringing the adjustment gear 136 back into engagement with the locking feature 141. Once the adjustment gear 136 is re-engaged with engagement with the locking feature 141, the second support 126 is locked at the current bend angle θ. The plurality of radially spaced teeth on the adjustment gear 136 enables the hinge 130 to be pivoted and locked at a plurality of discrete bend angles θ. The bend angle θ can be adjusted at discrete increments defined by the size of each of the plurality of radially-spaced teeth.

The specific hinge 130 arrangement described herein is merely one example of a hinge 130. Any other structure suitable for providing pivoting or bending functionality can alternatively be used. Some embodiments can include a motorized or electronic hinge arrangement.

### 3.3. End Cap

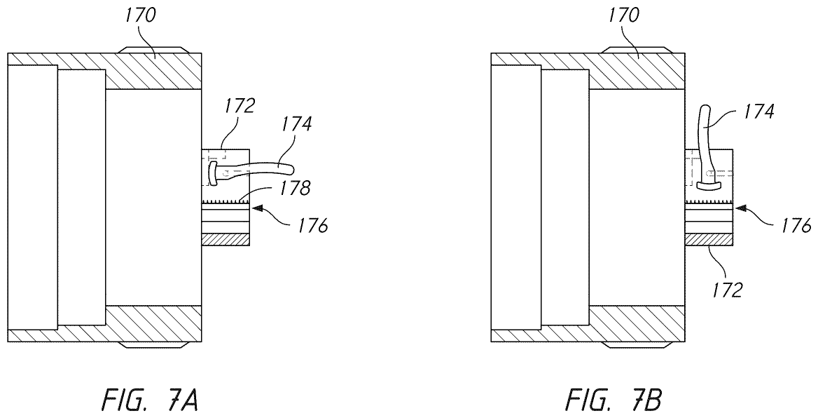

FIG. 7A and 7B depicts longitudinal cross-section views of the end cap 170 of the penile treatment device 100 of FIG. 1. The end cap 170 can couple the sleeve 110 to the frame 120. The sleeve 110 can be secured to the end cap 170 to maintain an amount of axial tension on the sleeve 110. The end cap 170 can be fixedly or detachably coupled to an extension segment 150 or to the second support 126. The end cap 170 can be coupled to an adjacent frame segment by threading, a snap-fit connection, a bayonet connector, mechanical fasteners, or any other suitable fastening means.

The end cap 170 can include a locking mechanism 172. The locking mechanism 172 can secure the sleeve 110 to the end cap 170. The locking mechanism 172 can include a release lever 174 and a lock channel 176. The lock channel 176 can be shaped to receive the elongate member of the sleeve 110. The elongate member can be threaded through the lock channel 176. In some embodiments, the lock channel 176 can include lock features for engaging with locking features on the elongate element 114. The lock features can include, but are not limited to, teeth, slots, recess, apertures, or the like. The release lever 174 can be moveable to transition the locking mechanism 172 between an unlocked configuration and a locked configuration

FIG. 7A depicts an end cap 170 of the penile treatment device 100 of FIG. 1 with a locking mechanism 172 in an unlocked configuration. When in the unlocked configuration, the lock channel 176 can be opened to allow the elongate element 114 to be threaded into the lock channel 176. When the locking mechanism 172 is in the unlocked configuration, the elongate element 114 can be advanced through lock channel 176 incrementally to increase or decrease axial tension on the sleeve 110. For example, locking features on the elongate element 114 can be incrementally engaged with lock feature in the lock channel 176 to incrementally advance the elongate element 114 through the locking mechanism 172.

FIG. 7B depicts the end cap 170 of FIG. 7A with the locking mechanism 172 in a locked configuration. As shown in FIG. 7B, the release lever 174 can be pivoted towards the end cap 170 to transition the locking mechanism 172 from the unlocked configuration to the locked configuration. When in the locked configuration, the lock channel 176 can secure the elongate element 114 in place at fixed location along the lock channel 176. When in the locked configuration, the elongate element 114 is inhibited from advancing or retracting through the lock channel 176. Accordingly, the locking mechanism 172 can be moved to the locked configuration to maintain axial loading on the sleeve 110. It is to be understood that the specific arrangement described herein is merely one example of a locking mechanism 172. Any other structure suitable for securing the sleeve 110 to the frame 120 can alternatively be used.

### 3.4. Extension Segment(s)

The penile treatment device 100 can include one or more extension segments 150 (e.g., a proximal extension segment 152 and/or a distal extension segment 154). The one or more extensions segments 150 can enable modular adjustment of the length L1 of the frame 120. In some embodiments, one or more extensions segments 150 can be installed into or omitted from the penile treatment device 100 to increase or decrease a length of the penile treatment device 100. Accordingly, the length L1 of the frame 120 can be personalized to accommodate a specific length of the user's penis 10 and/or a desired treatment location. One or more extension segments 150 can be installed to increase to the total potential stretching length of the penile treatment device 100 to increase the maximum potential amount of axial tension applied to the user's penis 10. The one or more extensions segments can be coupled to the proximal portion 121 of the frame 120 and/or the distal portion 122 of the frame 120.

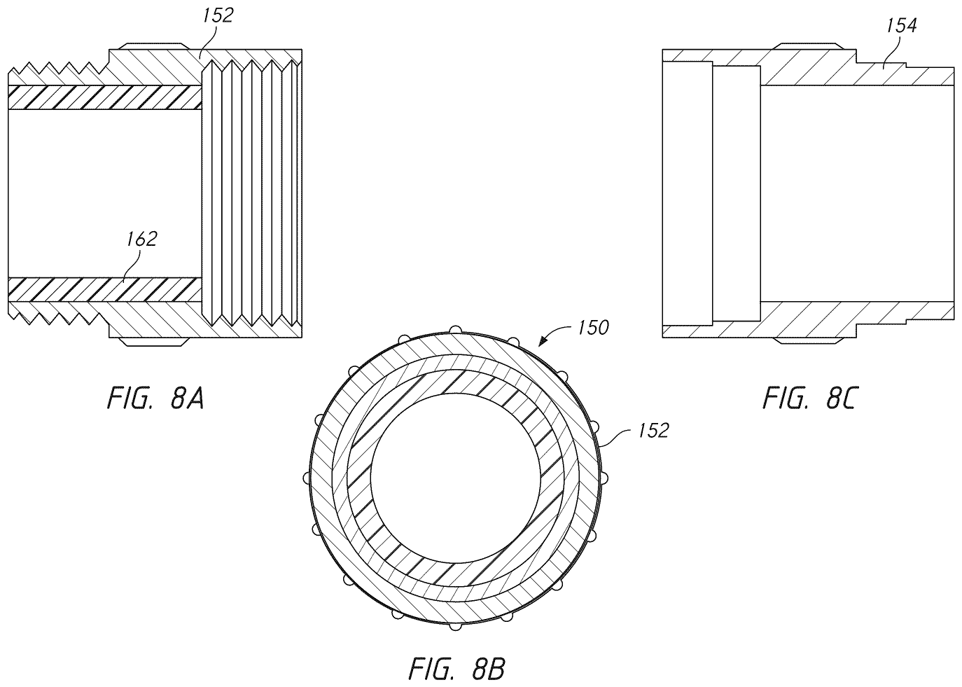

FIG. 8A depicts a longitudinal cross-sectional view of a proximal extension segment 152 of the penile treatment device 100 of FIG. 1. FIG. 8B depicts a transverse cross-sectional view of the proximal extension segment 152 of FIG. 8A. The one or more proximal extension segments 152 can be detachably coupled to the proximal portion 121 of the frame 120. As shown, the proximal extension segment 152 can be formed as a tubular structure. One or more grips 160 can be disposed on an outer surface of the proximal extension segment 152. Padding 162 can be disposed along an inner surface of the proximal extension segment 152.

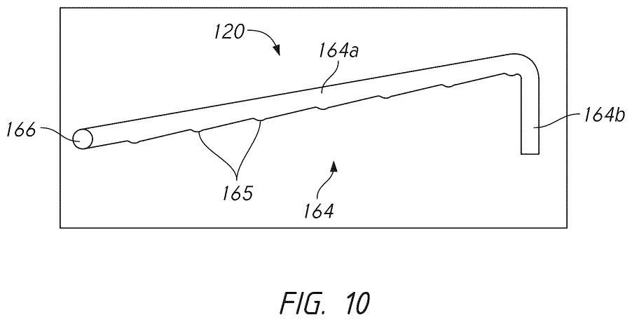

The proximal extension segment 152 can include step grooving 164 (see FIGS. 10 and 11C and the associated discussion below). One end of the proximal extension segment 152 can include step grooving 164 on an outer surface of the proximal extension segment 152. An opposing end of the proximal extension segment 152 can include step grooving 164 on an inner surface of the proximal extension segment 152. The step grooving 164 can enable the proximal extension segment 152 to be axially translated away from one or more adjacent frame segments (e.g., the body stop 140 and/or the first support 124) to incrementally increase a length L1 of the frame 120 to increase axial tension on the user's penis 10.

FIG. 8C depicts a longitudinal cross-sectional view of a distal extension segment 154 of the penile treatment device 100 of FIG. 1. The one or more distal extension segments 154 can be detachably coupled to the distal portion 122 of the frame 120. As shown, the distal extension segment 154 can be formed as a tubular structure. Opposing ends of the distal extension segment 154 can include snap-fit connections for coupling to adjacent frame segments (e.g., the second support 126 and/or the end cap 170). In some embodiments, the distal extension segment 154 can be coupled to the adjacent frame segment by any other fastening means, including but not limited to, threading, latches, belts, adhesives, clips, screws, mechanical fasteners, or the like. One or more grips 160 can be disposed on an outer surface of the distal extension segment 154. The distal extension segment 154 may or may not include padding 162.

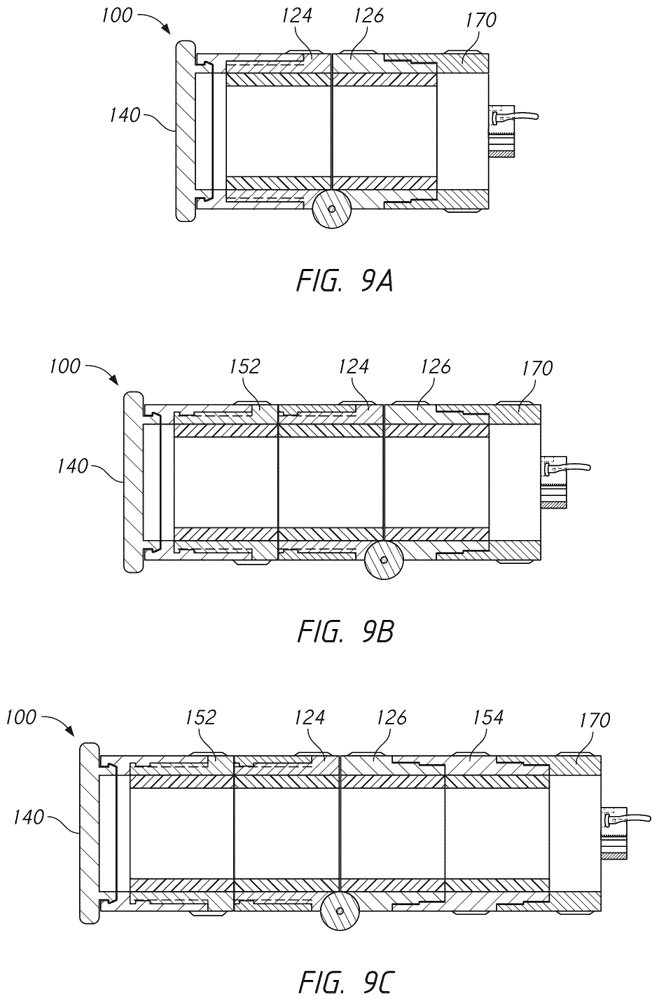

FIGS. 9A-9C depict various configurations of the penile treatment device 100 having different lengths. FIG. 9A depicts a longitudinal cross-sectional view of a penile treatment device 100 without extension segments 150 installed. As shown in FIG. 9A, when no extension segments 150 are installed, the body stop 140 can be directly coupled to first support 124, and the second support 126 can be directly coupled to the end cap 170. When no extensions segments 150 are installed, the penile treatment device 100 can have a relatively short length.

FIG. 9B depicts a longitudinal cross-sectional view of a penile treatment device 100 with a proximal extension segment 152 installed. As shown in FIG. 9B, the proximal extension segment 152 can be interposed between the body stop 140 and the first support 124. The proximal extension segment 152 can increase the length of the proximal portion 121 of the frame 120. In some configurations, two, three, or more proximal extension segments 152 can be installed into the proximal portion 121 to increase the length of the proximal portion 121.

FIG. 9C depicts a longitudinal cross-sectional view of a penile treatment device 100 with a proximal extension segment 152 and a distal extension segment 154 installed. As shown in FIG. 9C, the distal extension segment 154 can be interposed between the second support 126 and the end cap 170. The distal extension segment 154 can increase the length of the distal portion 122 of the frame 120. In some configurations, two, three, or more distal extension segments 154 can be installed into the distal portion 122 to increase the length of the distal portion 122.

In some configurations of the penile treatment device 100, any combination and number of proximal extension segments 152 and distal extension segments 154 can be included in the penile treatment device 100. The extension segments 150 can be selectively installed or omitted to change the relative location of the hinge 130 along the length of the penile treatment device 100. The modularity of the extension segments 150 can permit control over the relative location of the hinge 130 along the length of the penile treatment device 100. Control over the relative location of the hinge 130 along the length of the penile treatment device 100 can enable the user to position the hinge 130 such that the bending force is applied at a targeted position along the shaft of the user's penis 10 (e.g., at the region on the user's penis 10 with a concentration of plaque 20 build-up).

### 3.5. Step Grooving

One or more segments of the frame 120 (e.g. the body stop 140, the first support 124, the second support 126, the end cap 170, and/or the extension segments 150) can include step grooving 164. The step grooving 164 can be formed into one or more surfaces. The step grooving 164 can be a channel, recess, elongate blind hole, or otherwise. FIG. 10 depicts a schematic view of a flattened frame segment (a tubular frame segment “unrolled” into a flat configuration for purposes of presentation). As shown, the segment includes step grooving 164 on an interior wall of the frame 120. In some embodiments, the step grooving 164 can be formed as helical threading. The step grooving 164 can be formed on an interior surface and/or an exterior surface of some or each of the frame segments. As shown, the step grooving can include a first portion 164a and a second portion 164b. The first portion 164a can extend longitudinally and circumferentially, such as in a helical shape. The second portion 164b can extend circumferentially. The first portion 164a can have a plurality of increments, such as steps 165. A nipple 166 (e.g., protrusion, boss, etc.) can be positioned in and/or slid along the step grooving 164. In certain embodiment, detents, steps, or other locking features maintain the nipple 166 in position in the groove. The nipple can be on (e.g., project radially inwardly from) a portion of the frame that mates with the portion of the frame having the step grooving 164. This can enable one frame segment to be moved (e.g., stepped) relative to another frame segment.

Adjacent frame segments can be coupled together via the step grooving 164. Adjacent frame segments can be rotated relative to each other along the step grooving 164 and/or about the longitudinal axis to axially lengthen or shorten a distance between the two frame segments. When rotated relative to each other, step grooving 164 tracks of each respective frame segment can helically advance over each other to axially advance the two respective frame segments away or towards each other depending on the rotation direction. The step grooving 164 can enable incremental adjustment of the length L1 of the frame 120 of the penile treatment device 100. Accordingly, the step grooving 164 can enable incremental adjustment of the axial tension on the user's penis 10. In some embodiments, the step grooving 164 associated with each frame segment can provide about two inches of extension length to the penile treatment device 100. In some embodiments, each frame segment with step grooving 164 can provide more or less than two inches of additional extension length to the penile treatment device 100. One or more extension segments 150 with step grooving 164 can be installed to further increase the total possible amount of extension length.

The step grooving 164 can provide a generally continuous track for frame segments to advance along. In some embodiments, when frame segments are advanced beyond the end of their respective step grooving 164 tracks (e.g., when spaced apart by the maximum distance allowed by the step grooving 164 track), the generally continuous step grooving 164 track can guide the frame segments back to the beginning of the step grooving 164 track such that the frame segments are returned back together.

The specific step grooving 164 arrangement described herein is merely one example of a structure for axially lengthening the penile treatment device 100. Any other structure suitable for axially lengthening the penile treatment device 100 can alternatively be used (e.g., a ratcheting system, an elastic stretching system, or the like).

### 4. Method of Use

As mentioned above, the penile treatment device 100 can be used to treat aberrant curvature of the penis 10 caused by a build-up of plaque 20 under the skin of the penis 10. FIGS. 11A-11E depict steps in the operation of the penile treatment device 100 while being used to treat a penile condition of a user's penis 10. Initially, the frame 120 can be assembled in the desired configuration by installing the desired number of extension segments 150 according to the user's penile length and/or the desired stretching capabilities. FIGS. 11A-11E depict a configuration of the penile treatment device 100 with one distal extension segment 154 installed. However, the steps of operation described herein can be similar or identical for other configurations.

Before positioning the penis 10 within the frame 120, the sleeve 110 can be positioned over the user's penis 10. In some embodiments, the sleeve 110 can be disposed over the user's penis 10 such that the sleeve 110 circumferentially covers at least the head (e.g., glans) of the user's penis 10. In some embodiments, the sleeve 110 covers only the head. In some embodiments, a securing device can be placed over the sleeve 110 to provide additional securement of the sleeve 110 to the user's penis 10. In some embodiments, the securing device can be disposed just under the corona of the glans and/or over the sleeve 110. In some embodiments, the securing device can be an elastic band (e.g., rubber band), a string, or any other structure for circumferentially securing the sleeve 110 to the penis 10. In certain implementations, a protective wrap (e.g., cotton stretch wrap) is used. For example, the wrap can be applied directly to the head of the penis and/or the sleeve 110 can be applied over the wrap (e.g., and secured with the securing device). After the sleeve 110 has been coupled to the penis 10, the penis 10 can be positioned within the frame 120. For example, the frame 120 can be slid longitudinally over the user's penis. The frame can include one or more windows, channels, or other viewports to facilitate locating the frame in position relative to the penis.

FIG. 11A depicts a step in the operation of the penile treatment device 100 after the user's penis 10 has been initially positioned within the frame 120. As shown in FIG. 11A, the user's penis 10 can preferably be positioned within the frame 120 such that the hinge 130 is aligned with a target region on the penis 10 at which therapeutic bending is desired to be applied. For example, as shown in FIG. 11A, the hinge 130 can be aligned with a region of the user's penis 10 containing a build-up of plaque 20. The frame 120 can be rotationally oriented such that the hinge 130 is disposed on the side of the penis 10 that is opposite to the target region (e.g., the region of plaque 20). As shown in FIG. 11A, after the penis 10 is positioned within the frame 120, the elongate element 114 of the sleeve 110 can be threaded through the locking mechanism 172 of the end cap 170.

FIG. 11B depicts a step in the operation of the penile treatment device 100 after the sleeve 110 has been tensioned and radially contracted around the user's penis 10. As shown in FIG. 11B, after the elongate element 114 is threaded through the locking mechanism 172, the elongate element 114 can be advanced further through the end cap 170 to axially tension the sleeve 110. Axially tensioning the sleeve 110 causes the sleeve 110 to radially contract around and grip the user's penis 10. As shown in FIG. 11B, radial contraction of the sleeve 110 around the user's penis 10 can allow the sleeve 110 to grip the user's penis 10 and translate axial tension to the user's penis 10, thereby in certain embodiments causing the user's penis 10 to stretch and axially elongate within the frame 120.

The elongate element 114 can be advanced through the end cap 170 until a sufficient amount of axial tension and/or stretching of the penis 10 is achieved. In some embodiments, a user may preferably advance the elongate element 114 through the end cap 170 by the maximum allowable distance to maximize the amount of axial tension applied to the sleeve 110 and to the user's penis 10. After the elongate element 114 has been advanced through the end cap 170 by a desired amount, the locking mechanism 172 can be moved to the locked configuration to secure the elongate element 114 in place and maintain the current amount of axial tension on the sleeve 110 and the user's penis 10. As shown in FIG. 11B, the locking mechanism 172 can be moved to the locked configuration by moving the release lever 174 towards the end cap 170.

FIG. 11C depicts a step in the operation of the penile treatment device 100 after the length L1 of the frame 120 has been increased to provide additional axial tension on the user's penis 10. As shown in FIG. 11C, the first support 124 can be axially translated away from the body stop 140 to further increase axial tension and stretching of the penis 10. Rotation of the first support 124 relative to the body stop 140 axial can advance the first support 124 away from the body stop 140 via the step grooving 164. The user can axially advance the first support 124 away from the body stop 140 until a desired amount of axial tension and stretching of the user's penis 10 is achieved. In some embodiments, a user may preferably increase axial tension until the user experiences a maximum tolerable amount of pain due to penile stretching. If additional frame segments (e.g., one or more proximal extension segments 152) are included in the penile treatment device 100, the additional frame segments can be axially advanced away from adjacent frame segments to further increase the length L1 of the frame 120 and further increase axial tension on the user's penis 10.

FIG. 11D depicts a step in the operation of the penile treatment after the distal portion 122 of the frame 120 has been pivoted away from the proximal portion 121 of the frame 120. As discussed above, the hinge 130 can be moved from the locked configuration to a pivotable configuration by depressing the actuator 132 to move the adjustment gear 136 out of engagement with the locking feature on the hinge 130. While maintaining pressure on the actuator 132, the user can pivot the second support 126 relative to the first support 124 via the hinge 130 by manually applying a force to the second support 126. As shown in FIG. 11D, pivoting the hinge 130 can cause the second support 126 and the first support 124 to separate at the side of the frame 120 that is opposite to the hinge 130. Pivoting the second support 126 relative to the first support 124 can apply a transverse (e.g., lateral) bending force to the penis 10, which causes the penis 10 to bend. As shown in FIG. 11D, it can be preferable for the penis 10 to bend at the target region (e.g., at the region of plaque 20 build-up). The second support 126 can be pivoted away from the first support 124 by a bend angle θ. The user can increase the bend angle θ until a desired transverse bending force is applied to the user's penis 10. The bend angle can be any angle between 0 degrees and 180 degrees. To improve efficacy of the penile treatment device 100, the user may preferably arrange the penile treatment device 100 at a bend angle θ at which the user experiences the maximum tolerable amount of pain due to the transverse bending force.

The sleeve 110 can be disposed between the user's penis 10 and the frame 120 such that a middle portion 12 of the user's penis 10 does not contact the second support 126 and/or first support 124 when the second support 126 is pivoted relative to the first support 124. In various embodiments, the sleeve 110 provides a padded barrier between penis and the second support 126 and/or first support 124 when the second support 126 is pivoted relative to the first support 124.

FIG. 11E depicts a step in the operation of the penile treatment device 100 after the frame 120 has been locked at a desired bend angle θ. In the example shown in FIG. 11E, the bend angle θ is locked at a substantially right angle (e.g., about 90 degrees), though locking at many other angles is possible, such as at least about 10 degrees and/or less than or equal to about 120 degrees, 20 degrees and/or less than or equal to about 70 degrees, 30 degrees and/or less than or equal to about 60 degrees, or otherwise. The penile treatment device 100 can be locked at the desired bend angle θ by releasing the actuator 132 and transitioning the hinge 130 to the locked configuration. The penile treatment device 100 can be maintained at the desired bend angle θ for as long as therapeutic bending is desired to be applied to the penis 10. For example, in some treatment regimens, therapeutic bending can be applied for 5 minutes, 10 minutes, 20 minutes, 30 minutes, or longer. Over the course of a treatment period, one or more of the steps described above can be repeated to incrementally increase the bending angle θ of the penile treatment device 100.

After the treatment period has conceded, the penile treatment device 100 can be returned to its starting and/or straight configuration (e.g., the configuration depicted in FIG. 11A) by unlocking the hinge 130 and pivoting the second support 126 back to coaxial alignment with the first support 124. The user's penis 10 can be removed from the frame 120 by unlocking the locking mechanism 172 and detaching the elongate element 114 from the end cap 170. The user's penis can be removed from the sleeve 110 too.

### 5. Additional Embodiments

FIGS. 12A-14D depicts additional embodiments of the penile treatment device 100 and/or additional embodiments of individual components of the penile treatment device 100. Many of the features of the penile treatment devices 200, 300, 400 are the same as, or similar to, the features described above in connection with the penile treatment device 100. The penile treatment devices 200, 300, 400 can include one, some, or all of the features of the penile treatment device 100, including all combinations and sub-combinations. As mentioned above, any of the features of the devices 200, 300, 400 can be incorporated into the device 100 above and/or any of the features of the device 100 can be incorporated into any of the devices 200, 300, 400. For example, one or more of the open channel 290, beads 316, and first and second end cap portions 480, 482 can be incorporated into the device 100.

FIGS. 12A-12C depict a penile treatment device 200 according to a second embodiment. FIG. 12A depicts a transverse cross-sectional view of a frame 220 of the penile treatment device 200. As shown in FIG. 12A, the penile treatment device 200 can include an open-sided frame 220. One or more segments of the frame 220 can include an open channel 290 extending longitudinal along its side. The frame 220 can have a substantially U-shaped or C-shaped cross-section. In some embodiments, the open channel 290 can extend along an entire length L1 of the frame 220. In some embodiments, the open channel 290 can extend along only a portion of the length L1 of the frame 220. In some embodiments, the frame 220 can include two, three or mor open channels 290 or apertures. The open channel 290 can function as an access and/or viewing window for positioning the user's penis 10 within the frame 220. The open channel 290 can facilitate manipulation and operation of the penile treatment device 200 (e.g., by enabling the user to more easily thread the elongate element 114 through the end cap 270).

FIG. 12B depicts a transverse cross-sectional view of an end cap 270 of the penile treatment device 200. FIG. 12C depicts a longitudinal cross-sectional view of the end cap 270 of the FIG. 12B. As shown in FIG. 12B, the end cap 270 can include a wall 279 extending along a plane that is generally perpendicular to the central longitudinal axis A1 of the frame 220. A lock channel 276 of the locking mechanism 272 can extend through the wall 279. The lock channel 276 can be sized and shaped to receive the elongate element 114 therethrough.

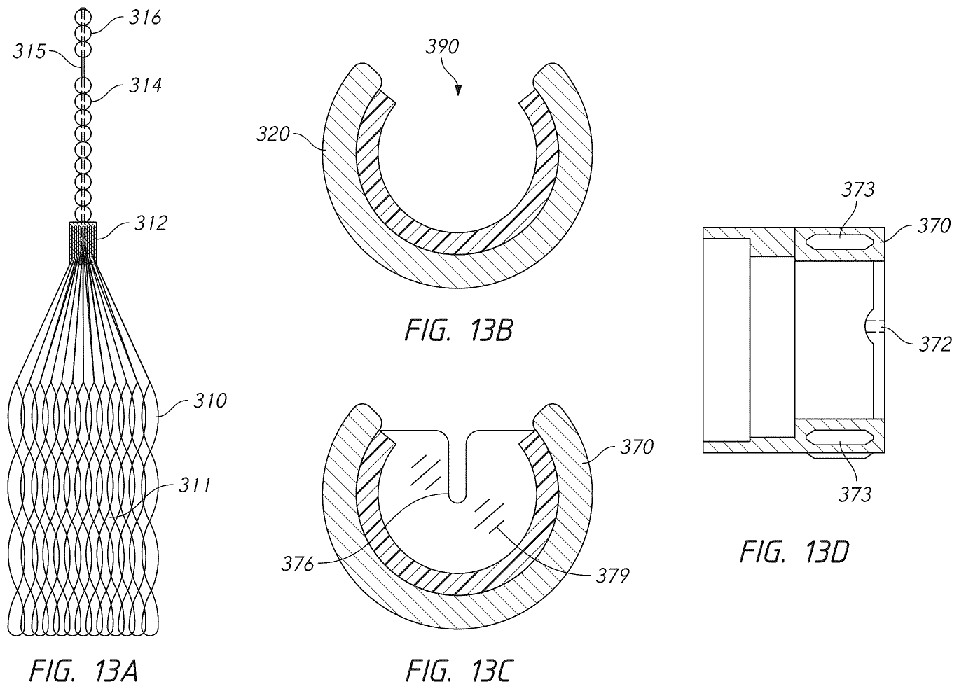

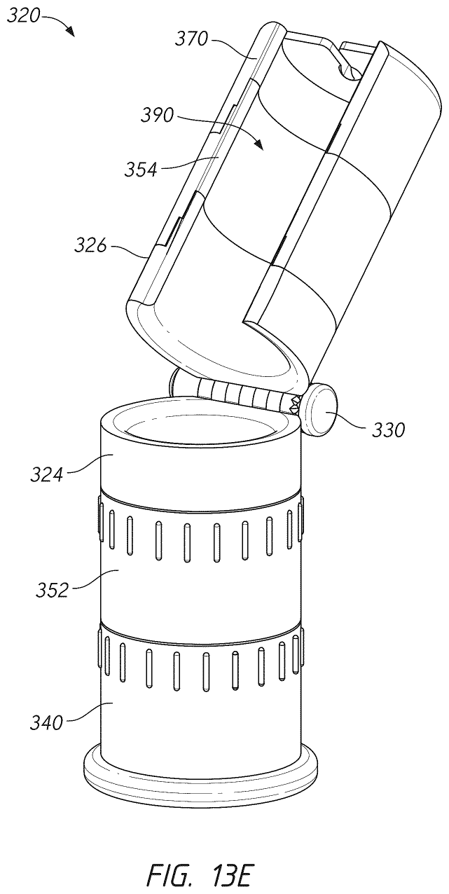

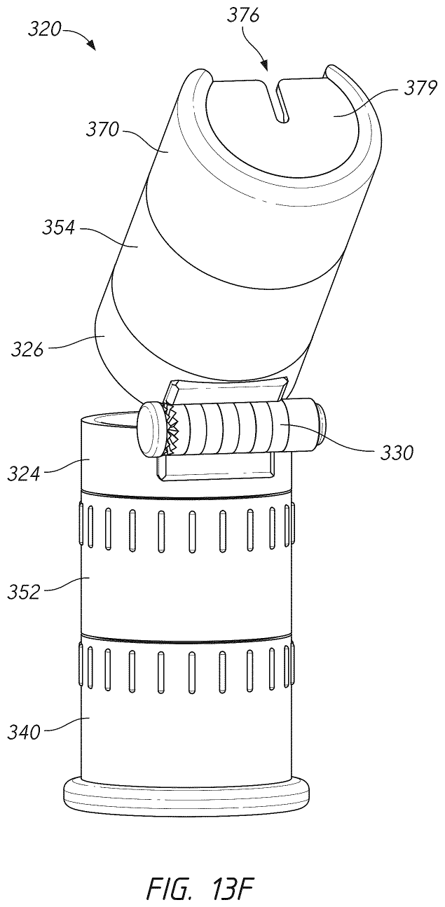

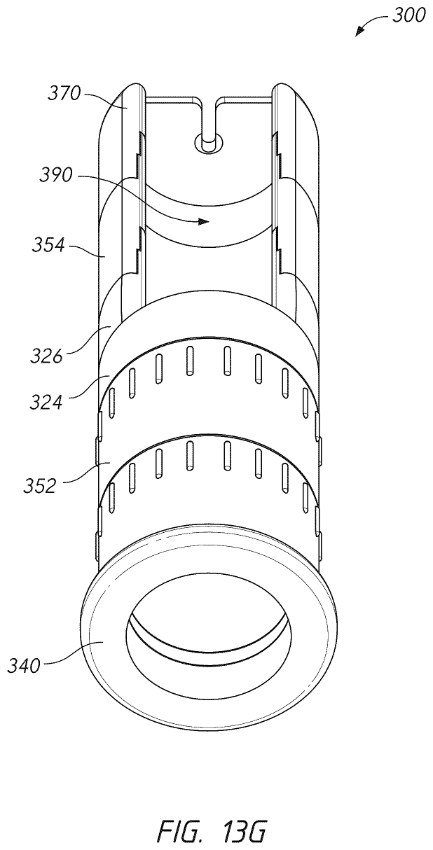

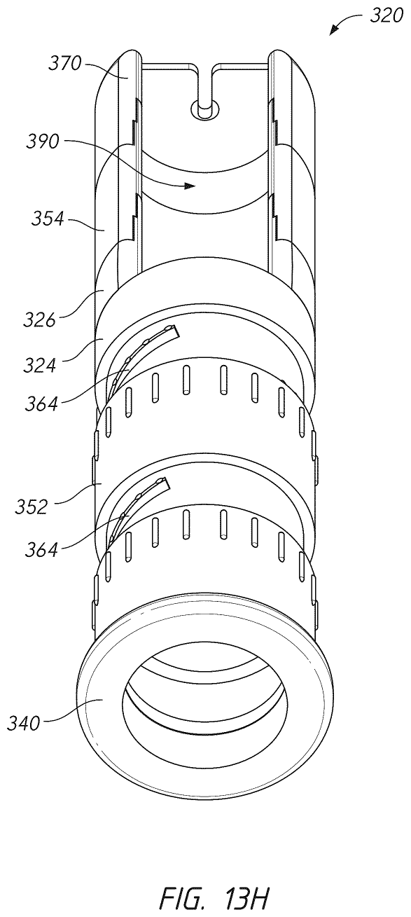

FIGS. 13A-13H depict a penile treatment device 300 according to a third embodiment. FIG. 13A depicts a sleeve 310 corresponding to the penile treatment device 300. As shown in FIG. 13A, the sleeve 310 can include a grasping portion 311, a securing element 312, and an elongate element 314. In certain variants, the elongate element 314 can include one or a plurality of positioning elements, such as beads 316. The positioning elements (e.g., beads 316) can function as locking features and/or be used for positioning and/or securing the elongate element 314 to a locking mechanism 372 of the end cap 370. Some variants have other locking mechanisms. The elongate element 314 can include an elongate body 315. The elongate body 315 can be a string, filament, cord, cable, attachment region, or otherwise. The elongate body 315 may be flexible or rigid. The beads 316 can be slidable along the elongate body 315 of the elongate element 314. The beads 316 can be grouped together along the elongate body 315 to form a gap between adjacent beads 316. The position of the gap along the elongate body 315 can be changed by changing the number of beads 316 on each side of the gap. With reference to FIG. 13A, a gap is formed between a grouping of three distal beads 316 and a grouping of nine proximal beads 316. The elongate element 314 can be secured to the end cap 370 via the gap in the beads 316.

FIG. 13B depicts a transverse cross-sectional view of a frame 320 corresponding to the penile treatment device 300. As shown in FIG. 13B, the frame 320 of the penile treatment device 300 can include an open channel 390. As shown, the frame can have a “C” or “U” shaped cross section. FIG. 13C depicts a transverse cross-sectional view of an end cap 370 of the penile treatment device 300. FIG. 13D depicts a longitudinal cross-sectional view of the end cap 370 of FIG. 13C. As shown in FIG. 13C, the end cap 370 can include a wall 379 extending along a plane that is generally perpendicular to the central longitudinal axis A1 of the frame 320. A lock channel 376 of the locking mechanism 372 can extend through the wall 379. The lock channel 376 can be, for example, an open-ended slot. The lock channel 376 can be shaped to receive the gap between beads 316 of the elongate element 314. The elongate element 314 can be coupled to the end cap 370 by slotting the gap between beads 316 into the lock channel 376. Beads 316 on either side of the gap can abut the wall 379 to resist axial motion of the elongate element 314 and lock the elongate element 314 in place. In operation, the grouping of beads 316 can be changed to incrementally adjust the position of the sleeve 310 and/or the amount of tension applied to the sleeve 310 and to the user's penis 10.

FIG. 13E depicts a front perspective view of the frame 320 in a bent configuration. FIG. 13F depicts a rear perspective of the frame 320 shown in FIG. 13E. FIG. 13G depicts a top perspective view of the frame 320 in a non-extended configuration. FIG. 13H depicts a top perspective view of the frame 320 in an extended configuration. As shown in FIGS. 13E-13H, the frame 320 can include a body stop 340, a proximal extension segment 352, a first support 324, and a pivot (e.g., a hinge 330). In certain embodiments, the frame 320 includes a second support 326, a distal extensions segment 354, and an end cap 370. As shown, the frame 320 can include step grooving 364. The step grooving 364 can be the same or similar to the step grooving 164 discussed above in connection with FIG. 10. The step grooving can enable one or more portions of the frame 320, such as the proximal extension segment 352 and/or the first support 324, to move (e.g., rotate and/or translate) relative to the body stop 340. Such movement can move the frame 320 between non-extended and extended configurations. As shown in FIG. 13F, the hinge 330 can facilitate pivoting the second support 326, distal extensions segment 354, and end cap 370 relative to the body stop 340, proximal extension segment 352, and first support 324 and/or the user's torso. The hinge 330 can be configured to facilitate maintaining the pivoted position. For example, the hinge 330 can be toothed and/or ratcheted. As shown, the hinge 330 can be circumferentially opposite the open channel 390. The open channel 390 can enable the user to see the distal end of the penis and/or the sleeve 310 during use of the device 300 and/or can facilitate adjustments (e.g., of the penis and/or the sleeve 310).

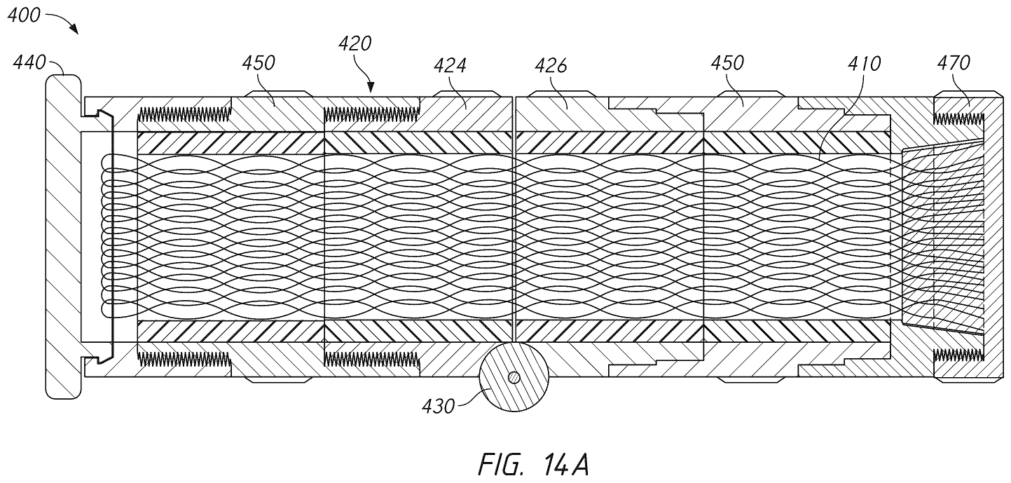

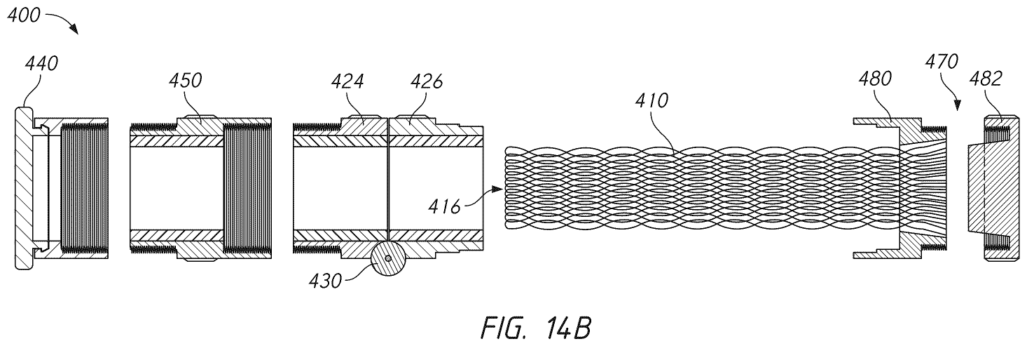

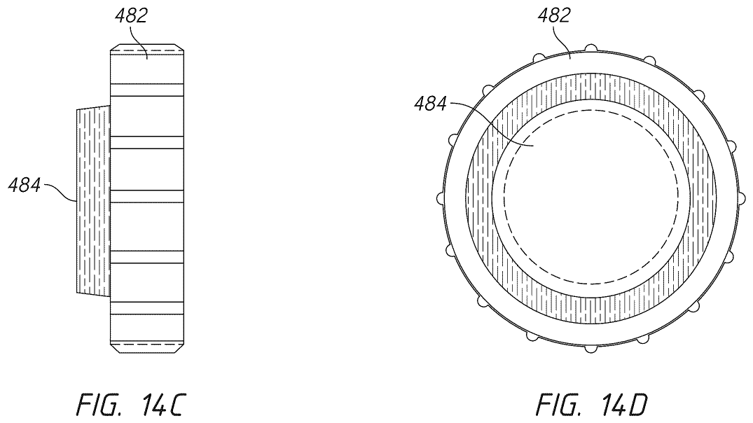

FIGS. 14A-14D depict a penile treatment device 400 according to a fourth embodiment. FIG. 14A depicts a longitudinal cross-sectional view of the penile treatment device 400 in an assembled state. FIG. 14B depicts an exploded view of the penile treatment device 400 of FIG. 14A. As shown in FIGS. 14A-14B, the penile treatment device 400 can include a sleeve 410 and a frame 420. The frame 420 can include a body stop 440, a first support 424, a second support 426, a hinge 430, an end cap 470, and one or more extension segments 450. As shown in FIGS. 14A-14B, in some embodiments, the sleeve 410 may not include a securing element 112 or an elongate element 114. Rather, the sleeve 410 can include two opposing open ends 416. The sleeve 410 can be dimensioned to extend over 50% of the length of the user's penis 10. In some embodiments, the sleeve 410 can be dimensioned to extend over substantially an entire length of user's penis 10.

A shown in FIGS. 14A-14B, the end cap 470 can include a first end cap portion 480 and a second end cap portion 482. One end of the first end cap portion 480 can be coupled to the second support 426 or to an extension segment 450. An opposing end of the first end cap portion 480 can be detachably coupled to the second end cap portion 482. FIG. 14C depicts a side view of the second end cap portion 482. FIG. 14D depicts a bottom view of the second end cap portion 482. The second end cap portion 482 can include a plug portion 484. The plug portion 484 can be inserted into the second end cap portion 482 to secure the first end cap portion 480 to the second end cap portion 482. One end of the sleeve 410 can be circumferentially interposed between the plug portion 484 and the first end cap portion 480 to secure the sleeve 410 to the end cap 470. The plug portion 484 can be tightly fit within the first end cap portion 480 such that mechanical pressure and friction holds the sleeve 410 to the end cap 470. The plug portion 484 can include a textured surface to provide additional grip on the sleeve 410. The end cap 470 can be made from rubber, polymers, plastics, or any other suitable materials.

### 6. Electronics and Sensing

Various embodiments of the devices 100, 200, 300, 400 can include electronic sensing and/or wireless communication functionality. For example, as shown in FIG. 13D, the cap can include sensors 373. Some embodiments have one or more sensors, such as length sensors, hinge angle sensors, rotation sensors, strain sensors, tension sensors, force sensors, etc. For example, the amount of bending, amount of elongation, and/or rotation or extension of one portion of the frame (e.g., relative to another portion of the frame) can be sensed. Some embodiments may comprise some form of sensor such as, digital, analog, brush, beam, or magnetic. Certain embodiments may have a load sensor (e.g., on the cap portion) to determine an amount (e.g., pounds) of force. Some implementations have one or more embedded indicators or sensors, on one or more segments. The sensors can allow the user to monitor progress, length change, angle change, or other aspects. Some embodiments are configured to wirelessly communicate (e.g., via radio frequency (RF), Bluetooth®, or otherwise) with a smartphone, wearable device, or other computing device running a corresponding app or other software. Some embodiments can enable a user to record duration logs, goals, or reminders. Certain embodiments of the devices 100, 200, 300, 400 include a power source (e.g., battery) to provide electric power to the sensors and/or wireless communication functionality. Some embodiments of the devices 100, 200, 300, 400 have a controller (e.g., an electronic processor and a memory) to control the sensors and/or wireless communication. Some embodiments provide feedback to the user, such as with lights, sound, or otherwise. For example, during use, when the device is bent to at least a certain angle (e.g., a minimum treatment angle), the device can illuminate a light, emit a sound, and/or communicate with the smartphone to start a timer. In certain embodiments, a safety alert can be issued (e.g., by the device and/or the computing device) in response to an amount of force, bending angle, etc. is too high (e.g., greater than or equal to a user-adjustable threshold), which can risk tearing the interior penile shaft or other injuries.

### 7. Terminology

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees and term “generally perpendicular” can refer to something that departs from exactly perpendicular by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### 8. Summary

Although the penile treatment devices and methods have been disclosed in the context of certain embodiments and examples, the penile treatment devices and methods extend beyond the specifically disclosed embodiments to other alternative embodiments and/or uses of the embodiments and certain modifications and equivalents thereof. Various features and aspects of the disclosed embodiments can be combined with or substituted for one another in order to form varying modes of the invention. The scope of this disclosure should not be limited by the particular disclosed embodiments described herein.

Certain features that are described in this disclosure in the context of separate implementations can also be implemented in combination in a single implementation. Conversely, various features that are described in the context of a single implementation can also be implemented in multiple implementations separately or in any suitable subcombination. Although features may be described above as acting in certain combinations, one or more features from a claimed combination can, in some cases, be excised from the combination, and the combination may be claimed as any subcombination or variation of any subcombination.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying drawings. The figures are drawn to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

In summary, various embodiments and examples of penile treatment devices and methods have been disclosed. Although the penile treatment devices and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described above, but should be determined only by a fair reading of the claims that follow.

1. A penile treatment device comprising:
a sleeve configured to receive a penis of a human body, wherein the sleeve is configured to radially contract around and grip the penis in response to axial tension; and
a frame configured to be disposed at least partly around the sleeve and extend along at least a portion of a length of the penis, the frame comprising:
a first support;
a second support pivotably coupled to the first support, wherein the second support is configured to apply a transverse bending force to the penis when the second support is pivoted relative to the first support; and
an end cap coupled to the second support, wherein the end cap is configured to secure the sleeve to the frame.

2. The penile treatment device of claim 1, wherein the frame further comprises a body stop 140 configured to abut a pubic region of a user, wherein a length of the frame can be extended by axially translating the first support away from the body stop 140 to increase axial tension on the penis.

3. The penile treatment device of claim 2, wherein the frame comprises step grooving configured to enable incremental lengthening of the frame via rotation of the first support relative to the body stop.

4. The penile treatment device of claim 2, wherein the body stop 140 comprises a first portion configured to abut the pubic region of the user and a second portion coupled to the first support, wherein the second portion is rotatable relative to the first portion about a central longitudinal axis of the frame.

5. The penile treatment device of claim 1, wherein the sleeve comprises:
an open end;
a closed end disposed opposite to the open end; and
an elongate element extending from the closed end, wherein the elongate element is configured to be coupled to the end cap to axially tension to the sleeve.

6. The penile treatment device of claim 5, wherein the end cap comprises a locking mechanism configured to receive and secure the elongate element to the end cap, wherein the elongate element is axially translatable through the locking mechanism to increase or decrease axial tension on the sleeve.

7. The penile treatment device of claim 5, wherein the elongate element comprises a beaded cord.

8. The penile treatment device of claim 5, wherein the closed end of the sleeve is secured together by a securing element.

9. The penile treatment device of claim 1, wherein the sleeve comprises a woven mesh structure.

10. The penile treatment device of claim 2, wherein the frame further comprises an extension segment configured to detachably couple to the frame to extend a length of the frame.

11. The penile treatment device of claim 10, wherein the extension segment is disposed between the body stop and the first support.

12. The penile treatment device of claim 1, wherein the second support is pivotable relative to the first support about a pivot axis that is substantially perpendicular to a central longitudinal axis of the frame.

13. The penile treatment device of claim 1, wherein the first support and the second support are pivotably coupled by a hinge, wherein the hinge comprises an actuator, wherein the actuator is actuatable to move the frame between a first configuration in which second support is freely pivotable relative to the first support and a second configuration in which the second support is locked at an bend angle relative to the first support.

14. The penile treatment device of claim 13, wherein the hinge further comprises a spring configured to bias the frame to the second configuration.

15. The penile treatment device of claim 13, wherein the hinge further comprises a gear configured to enable incremental adjustment of the bend angle.

16. The penile treatment device of claim 1, wherein second support is pivotable relative to the first support between an angle range of 0 degrees to 180 degrees.

17. The penile treatment device of claim 1, wherein the frame comprises an open-sided channel extending along at least a portion of a length of the frame.

18. A penile treatment device comprising:
a sleeve configured to receive a penis of a human body, the sleeve comprising:
a grasping portion configured to radially contract around and grip the penis in response to axial tension; and
an elongate element extending from the grasping portion; and
a frame configured to be disposed at least partly around the sleeve and extend along at least a portion of a length of the penis, the frame comprising:
a body stop configured to abut a pubic region of a user;
a first support coupled to the body stop, wherein the first support is configured to be axially translatable away from the body stop to increase axial tension on the penis by increasing a length of the frame;
a second support pivotably coupled to the first support by a hinge, wherein the second support is configured to apply a transverse bending force to the penis when the second support is pivoted relative to the first support; and
an end cap coupled to the second support, wherein the end cap is configured to secure the elongate element to the frame.

19. A penile treatment device comprising:
a sleeve configured to receive a penis of a human body, wherein the sleeve is configured to radially contract around and grip the penis in response to axial tension; and
a frame configured to be disposed at least partly around the sleeve and extend along at least a portion of a length of the penis, the frame comprising:
a first support;
a second support pivotably coupled to the first support, wherein the second support is configured to apply a transverse bending force to the penis when the second support is pivoted relative to the first support; and
an end cap coupled to the second support, wherein the end cap is configured to secure the sleeve to the frame,
wherein the sleeve is configured to be disposed between the penis and the frame such that a middle portion of the penis does not contact the second support or the first support when the second support is pivoted relative to the first support.

20. The penile treatment device of claim 19, wherein the frame further comprises a body stop configured to abut a pubic region of a user, wherein a length of the frame can be extended by axially translating the first support away from the body stop to increase axial tension on the penis.
